(19) United States
(12) Patent Application Publication
(10) Pub. No.: US 2015/0095195 A1
(43) Pub. Date: Apr. 2, 2015

(54) CONTENT DISCOVERY VIA TAGS

(71) Applicant: Google Inc.

(72) Inventors: Roy Want, Los Altos, CA (US); William Noah Schilit, Mountain View, CA (US)

(21) Appl. No.: 14/039,310

(22) Filed: Sep. 27, 2013

(51) Int. Cl. G06F 17/30; G06Q 20/12; G06Q 30/06

(52) U.S. Cl. CPC G06F 17/30755; G06F 17/30053; G06Q 30/0625; G06Q 20/123
USPC 705/26.62; 707/736

(57) ABSTRACT

Content provided at a venue may be stored to a database by associating the content provided with a content identifier and a venue identifier. In some configurations, the play time indicator may be associated with the content identifier and venue identifier. A query may be received based on a scan of a static, machine-readable computer code. The query may request a search of the database to be performed in order to identify the content provided at the venue. The query may be for content that is currently playing or for content that has been played at the venue within a defined time frame. A response to the query may be provided that identifies the content for the venue. The response may be provided, for example, to a smartphone belonging to a user and may present a purchase option for the content.

### BACKGROUND

A user may enter a restaurant and hear a song that the user would like more information about, and perhaps have access to a mechanism by which the user can purchase the song. The user may perform a search for a musical artist using a mobile device, but this can be time consuming and the user may not know the artist who made the song. Some applications exist that recognize the audio of a played song and attempt to match it to a particular known song. But these apps require that the user has installed such an application and they utilize audio instead of a text input.

### BRIEF SUMMARY

According to an implementation of the disclosed subject matter, content may be provided to a venue. A content identifier and a venue identifier may be received. The content identifier may correspond to the content currently playing at the venue. A query to identify the content currently playing at the venue may be received. The query may be based on a scan of a static machine-readable code at the venue. Responsive to the query, a purchase option for the content currently playing at the venue may be provided based on the content identifier and the venue identifier.

In an implementation, content may be provided to a venue. An indication of the content being provided to the venue may be received. A query from a device located at the venue may be received. The query may be based on a static machine readable code at a venue. An identifier of the content at the venue may be provided to the device.

In an implementation, a first content identifier may be obtained that corresponds to past content that played at a venue and it may be stored. A second content identifier may be obtained that corresponds to content currently playing at the venue and it may be stored. A query may be received based on a static machine readable code at the venue. The past content associated with the first content identifier and the content associated with the second content identifier may be provided.

In an implementation, a first indication of the content provided at a venue may be obtained. A second indication of a user device at a venue may be received. A query from the user device for the content at the venue may be received. Responsive to the query, an identification of the content may be provided based on the first indication and second indication.

In an implementation, a content identifier, a venue identifier, and a play time indicator may be received. The content identifier may correspond to content played at the identified venue at the play time indicator. A query may be received based on a scan of a static machine-readable code at the venue. The venue and a time reference may be identified based on the query. A query content identifier may be determined based on the identified venue, the identified time reference, the received content identifier, the received venue identifier and the play time indicator.

According to an implementation, a system is provided that includes a content module configured to provide content to a venue and a processor communicatively coupled to the content module. The processor may be configured to receive a content identifier and a venue identifier, the content identifier corresponding to the content currently playing at the venue. It may receive a query to identify the content currently playing at the venue. The query may be based on a scan of a static machine-readable code at the venue. Responsive to the query, the processor may provide a purchase option for the content currently playing at the venue based on the content identifier and the venue identifier.

In an implementation, a system is provided that includes a content module configured to provide content to a venue and processor. The processor may be configured to receive an indication of the content being provided to the venue. It may receive a query from a device located at the venue. The query may be based on a static machine readable code at a venue. The processor may be configured to provide an identifier of the content at the venue to the device.

A system is provided that includes a database for storing a first content identifier and a second content identifier. The system also contains a processor that is configured to obtain the first content identifier that corresponds to past content that played at a venue and store the first content identifier to the database. The processor may be configured to obtain the second content identifier that corresponds to content currently playing at the venue and store it to the database. The processor may receive a query based on a static machine readable code at the venue. The processor may provide the past content associated with the first content identifier and the content associated with the second content identifier.

In an implementation, a system containing a database and a processor communicatively coupled thereto is provided. The database may store a first indication of content provided at a venue. The processor may be configured to obtain the first indication of the content provided at a venue. It may receive a second indication of a user device at a venue. The processor may receive a query from the user device for the content at the venue. Responsive to the query, the processor may provide an identification of the content based on the first indication and second indication.

A system is provided in an implementation that includes a processor communicatively coupled to a database. The database may store one or more of a content identifier, a venue identifier, and a play time indicator. The processor may be configured to receive the content identifier, the venue identifier, and the play time indicator, the content identifier corresponding to content played at the identified venue at the play time indicator. The processor may receive a query based on a scan of a static machine-readable code at the venue and it may identify the venue and a time reference based on the query. It may determine a query content identifier based on the identified venue, the identified time reference, the received content identifier, the received venue identifier and the play time indicator.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 is an example method for providing an indication of content currently playing at a venue.

FIG. 4 is an example method to obtain an identifier of content provided to a venue.

FIG. 5 is an example method for providing an indication of past content and current content as disclosed herein.

FIG. 6 is an example method for providing an identification of the content provided at a venue.

FIG. 7 is an example method for providing a query content identifier according to an implementation disclosed herein.

FIG. 8 is an example system for providing an indication of content currently playing at a venue.

FIG. 9 is an example system to obtain an identifier of content provided to a venue.

FIG. 10 is an example system for providing an indication of past content and current content as disclosed herein.

FIG. 11 is an example system for providing an identification of the content provided at a venue.

FIG. 12 is an example system for providing a query content identifier according to an implementation disclosed herein.

### DETAILED DESCRIPTION

Systems and methods are disclosed in which a venue plays songs through a cloud-based service. The songs may be associated with a static QR code or NFC tag such that if the venue changes the songs in the playlist or the playlist itself, the new songs and/or playlist may be associated with the same static tag. One way to track the audio/video playback in a venue is through a scrobbling tool. Another way is for the venue to track the media being provided is to use a microphone in conjunction with song recognition software to provide a track list to a service. A user may scan a static tag at the venue. The tag may encode a web-query that asks, for example, “what song is playing at this venue?” The result of the query may direct the user to an online music vendor or cloud service through which the user can purchase the song.

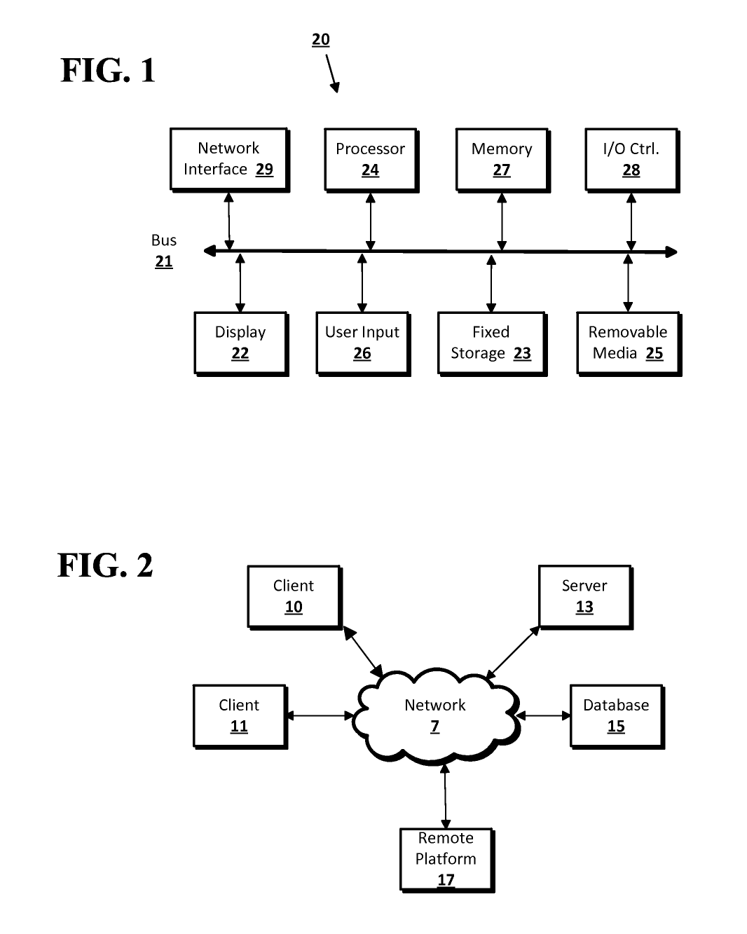

Implementations of the presently disclosed subject matter may be implemented in and used with a variety of component and network architectures. FIG. 1 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

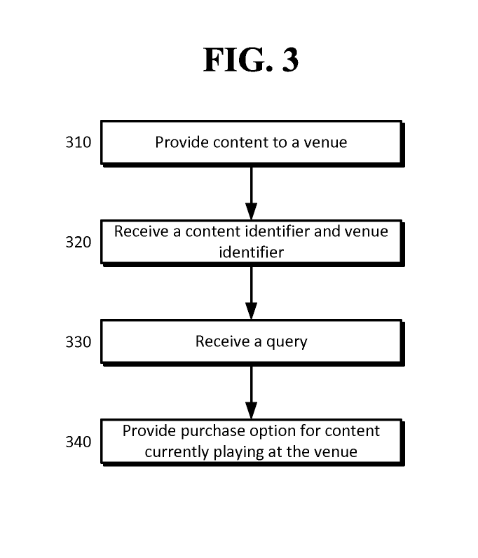

In an implementation, an example of which is provided in FIG. 3, content may be provided to a venue at 310. Content may refer to audio, video, etc. A content provider may have a database in which content is stored. In some configurations, a venue may have a cloud service that stores the venue's content. Content may be ordered in the form of a playlist and the content may be provided in the order proscribed by the playlist. Content may be streamed to the venue and the venue may play the content in substantially real-time.

A content identifier and a venue identifier may be received at 320. The content identifier may correspond to the content currently playing at the venue. A content identifier may be, for example, a title, an author, a serial number, an album name, or any combination thereof. For example, a content provider may stream a song entitled Song A. The title of the song may be received and/or stored. A time entry may also be stored with the content identifier and/or the venue identifier. A venue identifier may be, for example, a GPS signal, an IP address, and a device check-in, a radio beacon, and a Bluetooth beacon. For example, a GPS signal may be mapped onto a physical location or otherwise associated with a particular business establishment, name, address, telephone number, web site URL, etc. Thus, a venue identifier may refer to a signal that directly identifies a venue or that may indirectly identify a venue. For example, a user at a venue may receive a signal from a Bluetooth beacon at the user's mobile device (e.g., a smartphone). The beacon may inform the user's device of the venue's name or an alphanumeric sequence that uniquely identifies the venue. The user's device may transmit the venue's identifier with a query or request as described below. A venue identifier may also refer to any alphanumeric sequence (e.g., a business name, telephone number, address). Notably, the content identifier may be transmitted synchronously or asynchronously and each type of identifier may be sent more than one time. For example, a content identifier and venue identifier may indicate that Song A was played at Venue Z and may be stored as a database entry. A subsequent query of the database may also contain a venue identifier. The content identifier and/or the venue identifier may be stored.

A query may be received to identify the content currently playing at the venue at 330. The query may be based on a scan of a static machine-readable code. Machine-readable code may refer, for example, to: a text string, a SMS short code number, a near-field communication (“NFC”) tag, and a quick response (“QR code”) code. For example, a user may submit a query by scanning a QR code located at a table of a restaurant. Scanning the QR code may query a cloud service for what song is currently playing at the venue. The query may include a venue identifier. For example, when the user enters the restaurant (i.e., the venue), the user may utilize or connect with the restaurant's Wi-Fi. The network's identity may constitute a venue identifier according to any implementation disclosed herein and may be sent to a remote server for a response to the query. The user may check-in using a smartphone device or a device at a restaurant. Any query sent from the device may then be effectively stamped as originating from the particular venue into which the device is checked-in. The static machine-readable code itself may indicate that the query is from a particular venue in some configurations.

Responsive to the query, a purchase option for the content currently playing at the venue may be provided based on the content identifier and the venue identifier at 340. The purchase option may be presented by directing the query to a web site that includes the purchase option. For example, in response to the query, a device may receive a link to a web site that contains a purchase option for the content. The purchase option may be received by a device such as a smartphone that is linked to a user's account. The user may have the option of bookmarking the content corresponding to the content identifier returned in response to the query. Bookmarking the content may refer to storing a database entry containing an indication of the content and associating that entry with the user's account. Bookmarking may refer to sending the user an email that informs the user of the content identified in response to the query or the email may contain a link to a web site on which the user may purchase the content.

In some configurations, a query may contain a time reference or a playlist request. The time reference, for example, may be used to refer to a user's time spent in the venue as determined by a device check-in. A playlist may be generated for the venue based on the content identifier and the venue identifier. For example, for each time content is played at the venue, a content identifier may be used to identify the content and the content may be time-stamped. A query may be received for a playlist for the venue or that is querying content played at the venue during a specified time (e.g., the time a user's device is detected at a venue or time between user's device being first detected at the venue and the time of the query). A search may be performed for database entries for the venue between two time references or within a time interval. A playlist may be provided in response to the query representing the content played during the interval in chronological order, for example.

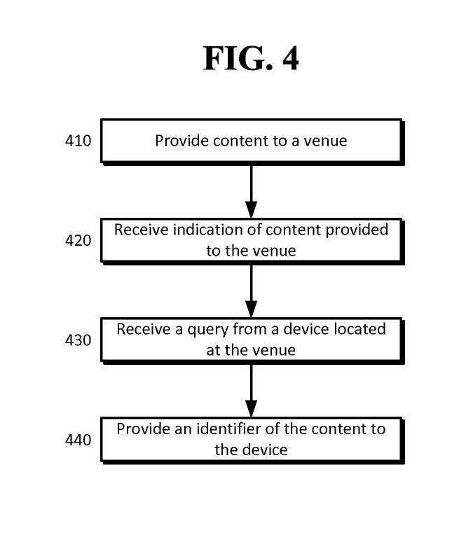

In an implementation, an example of which is provided in FIG. 4, content may be provided to a venue at 410. An indication of the content being provided to the venue may be received at 420. For example, a content provider may have a streaming radio station. The venue may report to the content provider what music station it is streaming and the content being provided to the venue at the time of the streaming may be reported to or stored in a database along with the venue's identity. An indication of content being provided to the venue may include, for example, a serial number that uniquely identifies the content, a title, an author, an album name, etc. In some configurations, an indication of the venue may be received. This indication may be similar to the venue identifier described earlier. An indication of the venue may be the venue's name, address, telephone number, or any combination thereof.

A query may be received from a device located at the venue at 430. The query may be based on a static machine-readable code at the venue as described earlier. An identifier of the content provided to the venue may be provided to the device at 440. The content identifier, as described earlier, may be stored to a database and associated with the venue. The content identifier may have a time stamp to indicate a time reference during which the content was provided to the venue. In some configurations, the query may include a request for content provided to the venue during a specific time frame. A playlist may be generated for the venue based on the content identifier and the time frame requested. For example, a user may request the playlist of content provided to the venue for a particular day. To initiate the query, the user may scan a QR code with a smart phone and be directed to a web site that displays the content currently playing at the venue. The user may be provided an option to show content played within the last hour or the last day. Upon receiving an indication that the user has requested content beyond the currently playing content, a playlist may be generated corresponding to the selected option (e.g., content provided to the venue during the past hour or day). In some configurations, the response to the query may include a purchasing option. The purchase option may direct the query to a web site that includes the purchasing option or it may refer to bookmarking content as described earlier

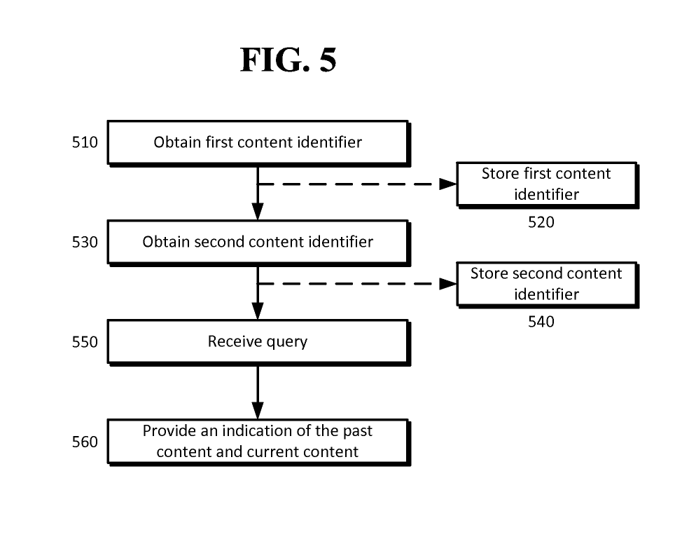

In an implementation, an example of which is provided in FIG. 5, a first content identifier that corresponds to past content that played at a venue may be obtained at 510. The first content identifier may be stored, for example, to a database in some configurations at 520. A second content identifier that corresponds to content currently playing at the venue may be obtained at 530. Similar to the first content identifier, the second content identifier may be stored at 540. For example, a venue such as a gas station or an airport waiting area may be streaming movie previews of TV shows and/or movies. The second content identifier may correspond to what is presently displayed at the venue. The first content identifier may refer to any content preceding the content currently playing at the venue. A database remote from the venue may receive one or more content identifiers from the venue itself, for example, if the venue is providing the content itself A database may receive content identifiers from a content provider in some configurations. For example, a content provider may stream audio, video, or other content to one or more venues. Within the stream of data sent by the content provider, an indication of what content is being provided may be present (e.g., a name of a song, an author, an artist, a serial number etc.). This metadata may be sent to and stored at a database as a content identifier as disclosed herein. As described earlier, a time reference and/or a venue identifier may be associated with a content identifier.

A query may be received based on a static machine-readable code at the venue at 550. An indication of the past content associated with the first content identifier and the content associated with the second content identifier (e.g., current content as shown in FIG. 5) may be provided at 560. For example, a user may scan a QR code at the venue and the phone's web browser may connect the user to the venue's playlist. The user may be presented with a purchasing option for the content contained in the playlist. Thus, providing content as disclosed at step 560 may refer to providing an indication of the content such as a playlist being provided on a web site or a link to a web site on which a playlist can be viewed. As described earlier, the playlist provided at 560 may be based on a time interval or time frame. A playlist may be generated based on the provided time frame.

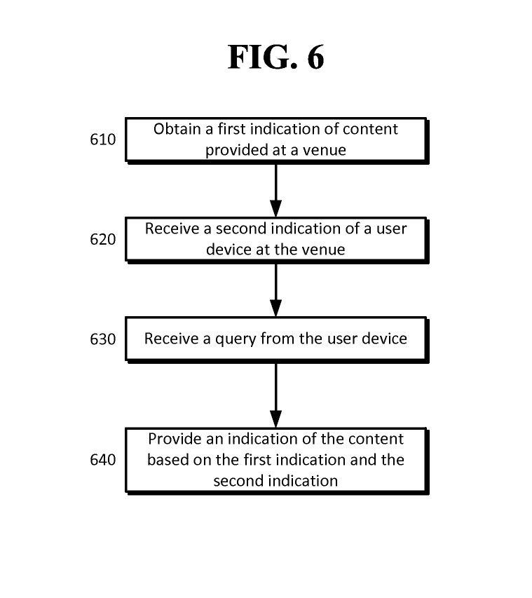

According to an implementation, an example of which is provided in FIG. 6, a first indication of content provided at a venue may be obtained at 610. For example, an indication of content (e.g., a content identifier) may include a title of a song or video, an author, a serial number, etc. A second indication of a user device at the venue may be received at 620. For example, the second indication may correspond to a device check-in at the venue, connecting to a venue's Wi-Fi network, a GPS signal that is coincident with a venue's location, etc. (e.g., a venue identifier as described earlier). A query from the user device for the content that is being played or has been played at the venue may be received or the query may be for the content itself at 630. The query may be based on a static machine-readable code. In some configurations, a venue may have devices from which a user can submit a query. The response to the query may be sent to the device and/or the user may be asked to provide a telephone number, email address, log into a user account to provide the response specifically to the user. At 640, responsive to the query, an identification of the content may be provided based on the first indication and the second indication.

The second indication of the user's device at a venue may be utilized to determine the location of the data in a database. For example, a database may contain data entries corresponding to content provided for or streamed to a variety of venues. The query may inquire as to what is currently playing at the venue or the query may specify a time interval. The query may be received by a processor that can access database entries corresponding to the content played and currently playing at the venue. The processor may return one or more database entries based on whether the query specifies a request for content currently playing at the venue, in which case the processor may obtain the last entry in the database, or a request for content played for an interval of time, in which case the processor may obtain database entries corresponding to the time interval. As described above, the response to the query may contain a purchasing option and/or the ability to bookmark the content provided for later retrieval and/or purchase by the user.

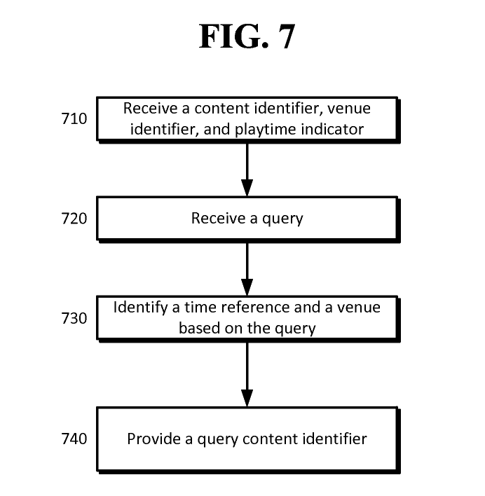

In an implementation, an example of which is provided in FIG. 7, a content identifier, venue identifier, and a play time indicator may be received at 710. A content identifier may correspond to content played at a venue associated with the venue identifier at a time specified by the play time indicator. A content identifier may correspond to one or more content items provided to the venue or played at the venue. It may include, for example, a title, an author, a serial number, and an album name as described earlier. A play time indicator may refer to a time, a date, a time range, a date range, etc. A play time indicator may specify a current time and/or a past time. A query may be received based on a scan of a static machine-readable code at the venue at 720. For example, a user may scan a QR code that is on a coaster at a restaurant (e.g., a venue) and the QR code may cause the query to be sent to a remote server. The machine-readable code may include a venue identifier and/or a link to a venue identifier. The venue and a time reference may be identified based on the query or data associated therein at 730. A query content identifier may be identified or provided based on the identified venue, the identified time reference, the received content identifier, the received venue identifier, and the play time indicator at 740. A query content identifier may refer to a response to the received query. The response to the query may include a purchase option as described earlier. The purchase option may be based on the query content identifier that may identify specific content played or currently playing at the venue according to the venue identifier and the play time indicator. The purchase option may include a link to a web site on which a purchase of content may be performed. In some configurations a playlist may be generated in response to the query as described earlier.

As an example, a venue such as an airport may play content for passengers. The identity of the content that is currently playing may be sent to a remote database in the form of a content identifier along with a venue identifier that may uniquely identify the airport as the venue to be associated with the content or content identifier. A play time indicator may be sent to the remote database along with the content and venue identifiers to time stamp the content identifier and venue identifier. A database entry may be made that includes all three of the aforementioned identifiers. A traveler at the airport may scan a QR code near one of the terminals playing content using a smartphone. The smartphone may transmit, as a component of the query, a venue identifier based on the QR code scan and/or a time reference. For example, the time reference may specify a period of time or the current time. The query may be directed toward the database in which the identifiers are stored. The venue and the time reference may be transmitted with the query or as a component thereof and may be used to look-up one or more database entries corresponding to the one or more identifiers provided. A response to the query may be returned in the form of a query content identifier.

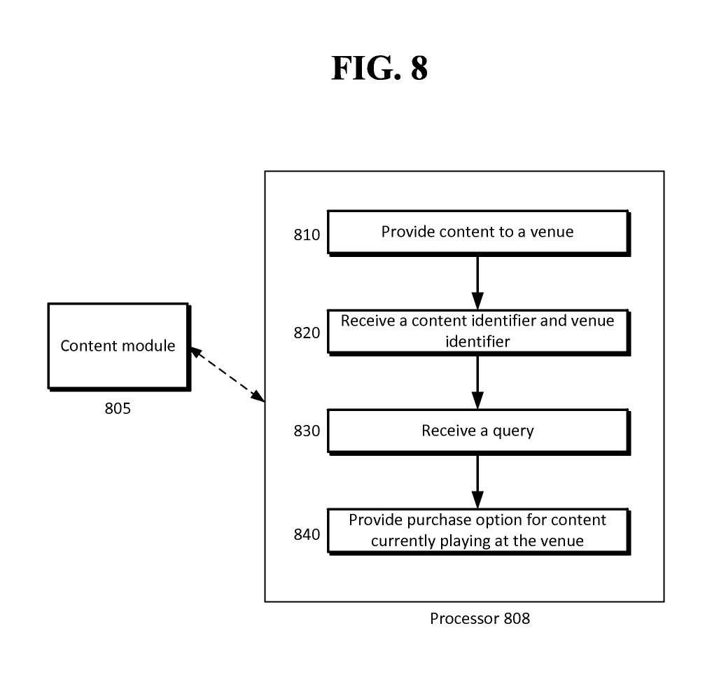

In an implementation, an example of which is provided in FIG. 8, a system is provided that includes a content module 805 and a processor 808 communicatively coupled thereto. A content module 805 may refer to a database or to computer readable storage and/or memory. In some configurations, a content module 805 may be a content provider or a service that streams data containing content such as a movie, an album, a playlist of songs, etc. The content module 805 may be configured to provide content to a venue 810, for example, by providing a data stream containing one or more of a song, a video, etc. The processor 808 may be configured to receive a content identifier and a venue identifier at 820. The content identifier may correspond to the content currently playing at the venue as described earlier. The processor 808 may receive a query to identify the content currently playing at the venue at 830. For example, the query may be based on a scan of a static machine-readable code at the venue. Responsive to the query, the processor 808 may provide a purchase option for the content currently playing at the venue based on the content identifier and the venue identifier 840.

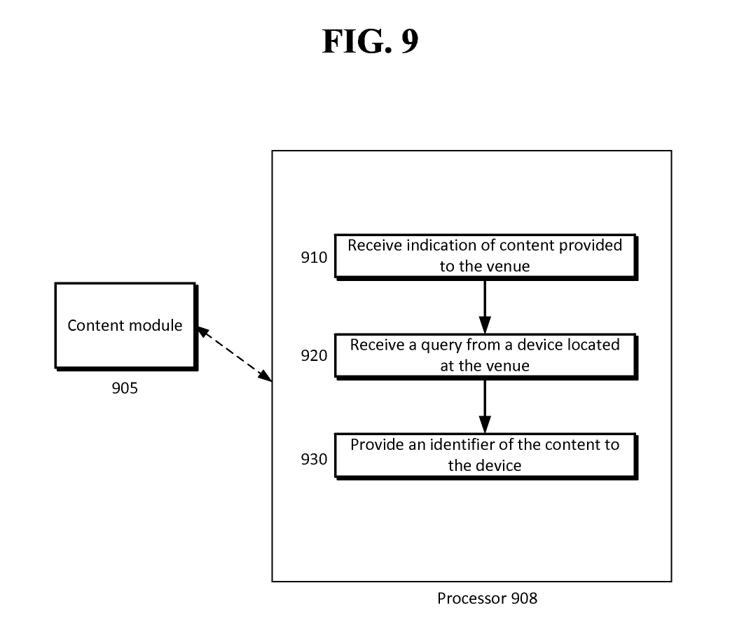

According to an implementation, as shown by the example provided in FIG. 9, a system that includes a content module 905 and a processor 908 is provided. The processor 908 may be configured to receive an indication of the content being provided to a venue 910. It may receive a query from a device located at the venue 920. The query, as described earlier, may be based on a static machine readable code at the venue. The processor 908 may be configured to provide an identifier of the content at the venue to the device 930. For example, an identifier of the content may be a title, an artist or author name, a serial number that uniquely corresponds to a specific piece of content, or any combination thereof. In some instances, an identifier of the content may be presented as a hyperlink to a web site on which the user can purchase the content.

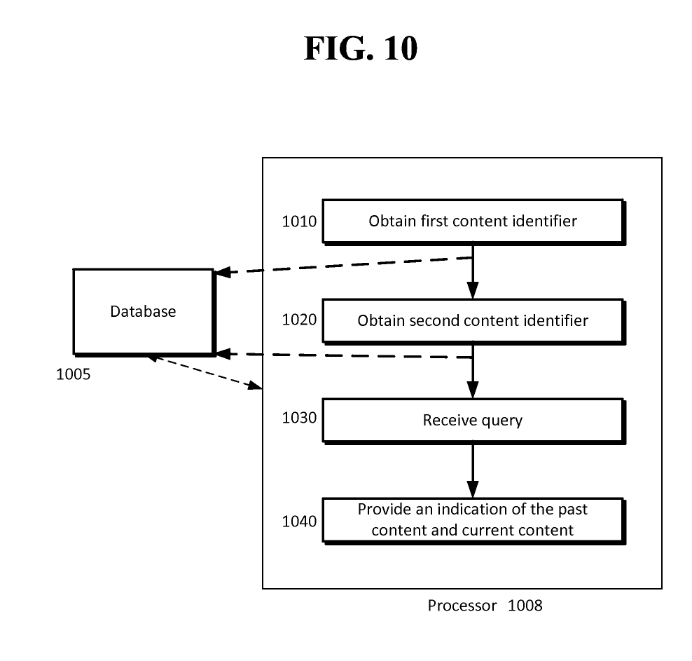

In an implementation, an example of which is provided in FIG. 10, a system is provided that includes a database 1005 for storing a first content identifier and a second content identifier. The system may include a processor 1008 that can communicate with the database 1005. The processor 1008 may be configured to obtain the first content identifier that corresponds to past content that played at a venue at 1010 and to store the first content identifier to the database 1005 or other computer readable storage. The processor 1008 may obtain the second content identifier that corresponds to content currently playing at the venue at 1020 and store the second content identifier to the database 1005 or other computer readable storage. The processor 1008 may be configured to receive a query based on a static machine readable code at the venue at 1030 and to provide the past content associated with the first content identifier and the content associated with the second content identifier at 1040.

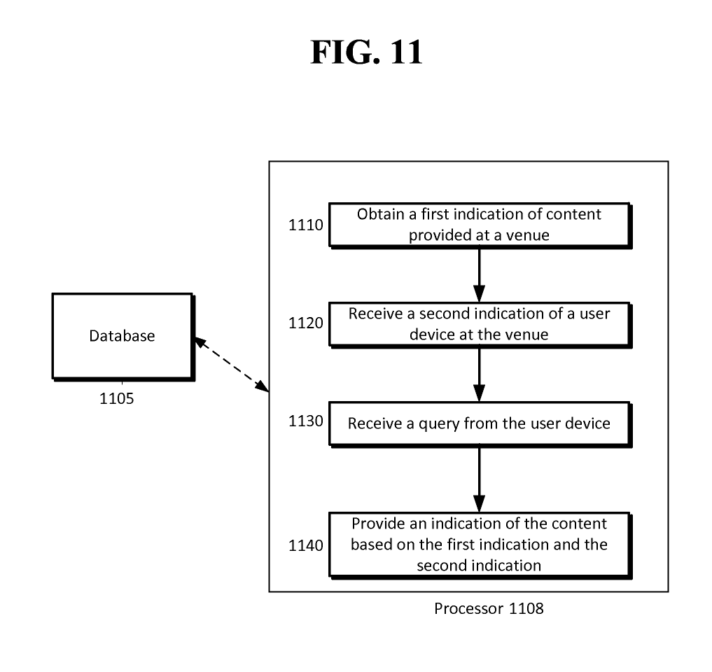

A system is provided that includes a database 1105 for storing a first indication of content provided at a venue and a processor 1108 communicatively coupled to the database 1105 as shown by the example provided in FIG. 11. The processor 1108 configured to obtain the first indication of the content provided at a venue at 1110. It may receive a second indication of a user device at a venue at 1120. The processor 1108 may receive a query from the user device for the content at the venue at 1130 and, in response to the query, it may provide an identification of the content based on the first indication and second indication 1140.

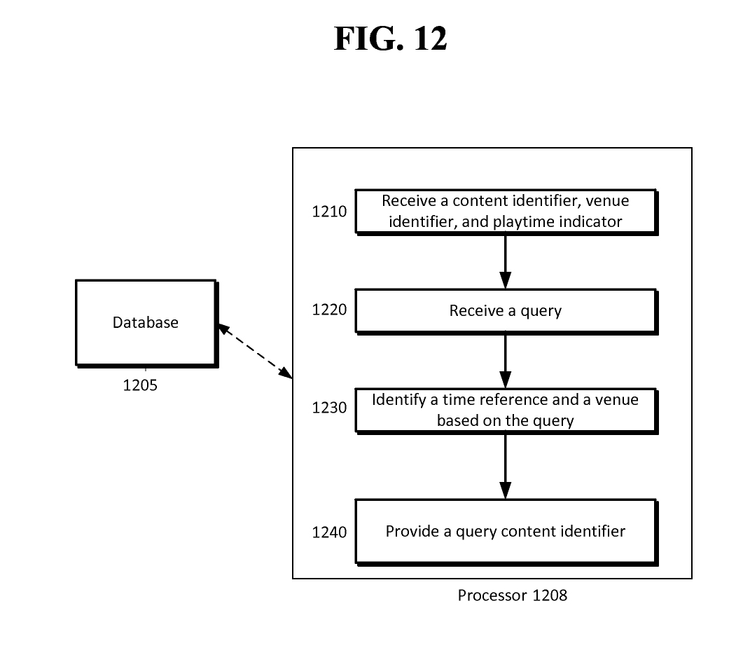

An example implementation of a system is shown in FIG. 12. The system may have a database 1205 for storing at least one of a content identifier, a venue identifier, and a play time indicator. A processor 1208 may be communicatively coupled to the database 1205 and configured to receive the content identifier, the venue identifier, and the play time indicator at 1210. The content identifier may correspond to content played at the identified venue at the play time indicator. The processor 1208 may receive a query based on a scan of a static machine-readable code at the venue at 1220 and identify the venue and a time reference based on the query 1230. The processor 1208 may determine a query content identifier based on the identified venue, the identified time reference, the received content identifier, the received venue identifier, and the play time indicator as described earlier 1240.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
obtaining a first content identifier that corresponds to past content that played at a venue;
storing the first content identifier;
obtaining a second content identifier that corresponds to content currently playing at the venue;
storing the second content identifier;
receiving a query based on a static machine readable code; and
providing the past content associated with the first content identifier and the content currently playing that is associated with the second content identifier.

2. The method of claim 1, wherein the step of providing comprises directing the query to a web site displays the past content and the content associated with the second content identifier.

3. The method of claim 1, wherein the step of providing comprises presenting a purchase option.

4. The method of claim 3, wherein the purchase option comprises bookmarking content corresponding to the content identifier.

5. The method of claim 1, wherein the query comprises a request for content provided to the venue during a specific time frame.

6. The method of claim 5, further comprising generating a playlist for the venue based on the content identifier.

7. A method, comprising:
receiving a content identifier, a venue identifier and a play time indicator, the content identifier corresponding to content played at a venue associated with the venue identifier at a time specified by the play time indicator;
receiving a query based on a scan of a static machine-readable code;
identifying the venue and a time reference based on the query; and
determining a query content identifier based on the identified venue, the identified time reference, the received content identifier, the received venue identifier and the play time indicator.

8. The method of claim 7, wherein the play time indicator is at least one from the group consisting of: a time, a date, a time range and a date range.

9. The method of claim 7, wherein the content identifier corresponds to at least one of a plurality of contents provided to the venue.

10. The method of claim 7, wherein the content identifier is selected from the group consisting of: a title, an author, a serial number, and an album name.

11. The method of claim 7, wherein the machine-readable code includes at least one from the group consisting of: a venue identifier and a link to a venue identifier.

12. The method of claim 7, wherein the play time indicator is selected from the group consisting of: a current time and a past time.

13. The method of claim 7, further comprising providing content based on the determined query content identifier.

14. The method of claim 7, further comprising providing a web site that includes a purchase option based on the query content identifier.

15. The method of claim 7, further comprising providing the content based on the query content identifier.

16. The method of claim 7, further comprising providing a purchase option of content played at the identified venue.

17. The method of claim 16, wherein the purchase option comprises bookmarking content corresponding to the content identifier.

18. The method of claim 7, wherein the venue identifier is selected from the group consisting of: a GPS signal, an IP address, and a device check-in, a radio beacon, and a Bluetooth beacon.

19. The method of claim 7, further comprising generating a playlist for the venue based on the content identifier, the identified time reference, and the venue identifier.

20. The method of claim 19, further comprising providing the playlist in response to the query.

21. The method of claim 7, wherein the machine readable code is selected from the group consisting of: a text string, a SMS short code number, a near-field communication tag, and quick response code.

22. A system, comprising:
a database for storing at least one of a content identifier, a venue identifier, and a play time indicator;
a processor communicatively coupled to the database, the processor configured to:
receive the content identifier, the venue identifier, and the play time indicator, the content identifier corresponding to content played at a venue associated with the venue identifier at a time specified by the play time indicator;
receive a query based on a scan of a static machine-readable code;
identify the venue and a time reference based on the query; and
determine a query content identifier based on the identified venue, the identified time reference, the received content identifier, the received venue identifier and the play time indicator.

23. The system of claim 22, wherein the play time indicator is at least one from the group consisting of: a time, a date, a time range and a date range.

24. The system of claim 22, wherein the content identifier corresponds to at least one of a plurality of contents provided to the venue.

25. The system of claim 22, wherein the content identifier is selected from the group consisting of: a title, an author, a serial number, and an album name.

26. The system of claim 22, wherein the machine-readable code includes at least one from the group consisting of: a venue identifier and a link to a venue identifier.

27. The system of claim 22, wherein the play time indicator is selected from the group consisting of: a current time and a past time.

28. The system of claim 22, the processor further configured to provide content based on the determined query content identifier.

29. The system of claim 22, the processor further configured to provide a web site that includes a purchase option based on the query content identifier.

30. The system of claim 22, the processor further configured to provide the content based on the query content identifier.

31. The system of claim 22, the processor further configured to provide a purchase option of content played at the identified venue.

32. The system of claim 31, wherein the purchase option comprises bookmarking content corresponding to the content identifier.

33. The system of claim 22, wherein the venue identifier is selected from the group consisting of: a GPS signal, an IP address, and a device check-in, a radio beacon, and a Bluetooth beacon.

34. The system of claim 22, the processor further configured to generate a playlist for the venue based on the content identifier, the identified time reference, and the venue identifier.

35. The system of claim 34, further comprising providing the playlist in response to the query.

36. The system of claim 22, wherein the machine readable code is selected from the group consisting of: a text string, a SMS short code number, a near-field communication tag, and quick response code.
